(19) United States
(12) Patent Application Publication
(10) Pub. No.: US 2009/0113720 A1
(43) Pub. Date: May 7, 2009

(54) Utility Knife

(76) Inventor: DOMINICK D. DELILLO, Pompano Beach, FL (US)

Correspondence Address: MELVIN K. SILVERMAN AND ASSOCS PC, 500 WEST CYPRESS CREEK ROAD, SUITE 350, FT. LAUDERDALE, FL, 33309, US

(21) Appl. No.: 11/936,402

(22) Filed: Nov. 7, 2007

(51) Int. Cl. B26B 5/00

(52) U.S. Cl. 30/162

(57) ABSTRACT

An improved utility knife has a blade housing, a handle region, and an end cap. The end cap is removably attached to the handle region. The handle region is cylindrical, with a slight taper and includes an interior storage chamber. The blade housing has a blade channel for holding a replaceable razorblade. A clench plate holds the razorblade securely within the blade channel of the blade housing.

### BACKGROUND OF THE INVENTION

1. Field of the Invention

The present invention relates to an improved utility knife designed for a variety of uses. Specifically, the invention provides a utility knife having a handle that is easily held firmly by an operator and directs the force of the operator's grip in the direction of the knife blade, while also stabilizing the blade.

2. Prior Art

Typical utility knives of the prior art are comprised of a substantially parallelepiped handle having an approximately rectangular cross section, as seen in U.S. Pat. Nos. 6,907,668, 7,131,204, 6,865,816 and 6,951,055. They may have either a stationary or retractable blade. It is common for replacement blades to be stored within the handle. The replacement blades are usually accessed by opening the handle, which is usually made of two halves held together by a screw, as shown in U.S. Pat. No. 7,186,067.

The typical shape of a utility knife handle does not provide the most ergonomically effective design for firmly grasping a knife and stabilizing a knife or transferring force applied by the hand of an operator to the blade of the knife. When a relatively large amount of force must be applied, and operator's hand may easily tire or slip along the handle. This ergonomic and mechanical inefficiency also provides a utility knife difficult for persons having decreased strength of grip, as commonly comes with increasing age. As life expectancy increases, it becomes more desirable to develop common household hand tools that are easily operated by persons with a relatively weaker grip.

Attempts have been made to improve the design of utility knife handles, as can be seen in U.S. Pat. No. 6,829,827, which employs a pistol-grip type handle. Such a design is only moderately effective but greatly increases the bulk of the knife, making it less practical for inclusion in a readily portable, compact tool box.

Because strong force is frequently applied to utility knives, it has been necessary to form them from strong, durable materials such as metals. More recently, it has become more practical to form utility knives from composite materials. These materials typically have smooth surfaces, increasing the difficulty of adequately gripping the handle. Such handles slip within an operator's grasp. In addition, the cast metal surface of such handles leads to blisters. More comfortable and more easily grasped plastics usually do not provide sufficient strength to the tool to be adequate material for manufacturing utility knives.

It is known to apply various coatings to the handle of a utility knife to increase gripping, as shown in U.S. Pat. Nos. 7,186,067 and 7,055,407. However, applying additional coatings during manufacture adds significant cost to production of the knives.

It is therefore desirable to provide an improved utility knife having an ergonomically effective handle.

It is also desirable to provide an improved utility knife having a handle that is easily gripped firmly.

It is also desirable to provide a utility knife handle that effectively transfers force from an operator's hand to the blade of the knife.

It is also desirable to provide a utility knife that can withstand the application of strong force, yet made of a lightweight and inexpensive material.

### SUMMARY OF THE INVENTION

The present invention provides an improved utility knife designed to efficiently transfer energy from the grip of an operator to the blade of the knife. The improved utility knife has a blade housing having minimal moving parts and design to direct force directly to the blade incorporated into the housing. The utility knife also has a slightly frusto-conical handle region designed to ergonomically engage an operator's hand to provide maximum ease of use. The tapered cylindrical design of the handle region allows any user to firmly grasp the knife, provides added strength to the entire knife and directs the force applied by an operator's grasp into the blade of the knife. The special ribbed design adds strength to the knife's design and improves gripping. The end cap of the knife also adds strength to the design and aids in transferring force into the incorporated blade.

The invention may be viewed as an utility knife including an elongate handle having a radially central longitudinal axis passing through a vertical plane thereof, the knife comprising (a) a removable hollow end piece having a form substantially of a semi-hemisphere having an equatorial cross-section thereof, said semi-hemisphere including an open end having a circumferential sequence of longitudinal ridges thereabout; (b) a central portion having proximal and a distal ends thereof, said proximal end including means for complemental engagement with said open end of said hollow end of said handle, said central portion defining a conical section having an axial tangent of between about 5 and about 15 degrees relative to said axis of said handle, said central portion having a greater diameter at said proximal end thereof than at said distal end thereof, said central portion including an axial sequence of circumferential ridges disposed on a lateral surface of said conical section; (c) a distal end integrally depending from said distal end of said central portion, said distal end including a recess upon one side thereof, said recess proportioned for complemental, axially slidable engagement with an elongate cutting blade of said knife; and (d) means for selectably securing said blade within said recess.

The handle and end cap of the utility knife may be separated to expose an interior chamber within the handle region of the knife. This chamber provides ample room to store replacement blades. The design of the blade housing allows for rapid replacement in securing of blades into the knife.

The design of the improved utility knife disclosed herein allows a sturdy, durable and effective utility knife to be formed from inexpensive plastics, composite materials or other inexpensive materials. The relatively large size of the handle and its ribbed surface make it easy to operate, even by someone with a relatively weak grip.

It is therefore an object of the present invention to provide an improved utility knife having an easily gripped handle having an interior storage chamber and a blade housing having relatively few moving parts.

The above and yet other objects and advantages of the present invention will become apparent from the hereinafter set forth Brief Description of the Drawings, Detailed Description of the Invention, and Claims appended herewith.

### BRIEF DESCRIPTION OF THE DRAWINGS

FIG. 1 shows a perspective view of the invention.

FIG. 2 shows a side view of the invention.

FIG. 3 shows a side view of the invention.

FIG. 4 shows a top view of the invention.

FIG. 5 shows a bottom view of the invention.

FIG. 6 shows a perspective view of a blade channel of the present invention.

FIG. 7 shows an exploded view of a clench plate, securing screw and retaining washer of the present invention.

FIG. 8 shows a perspective view of the end cap and handle region of the present invention.

### DETAILED DESCRIPTION OF THE INVENTION

The present invention is an improved utility knife having a central handle region that is cylindrical and slightly tapered. The handle region is designed for superior gripping and directing applied force. It also includes a blade housing that firmly holds a razorblade in place angled slightly downward relative to the handle region. The invention also preferably comprises an end cap that is geometrically optimized to direct applied force. The features of the improved utility knife allow it to be made inexpensively and to efficiently direct applied force through the handle into the blade. Its relatively light weight, easy grip handle and force directing features make it suitable for any operator, but also particularly for operators having a weakened grip.

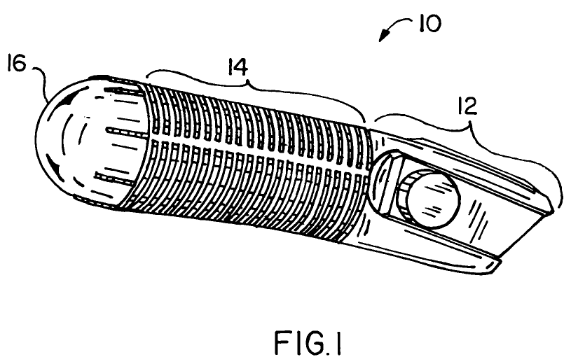

FIG. 1 shows a perspective view of a preferred embodiment of the invention. Utility knife 10 has a blade housing 12, a handle region 14 and an end cap 16. End cap 16 is removably attached to handle region 14. Both end cap 16 and handle region 14 have a diameter of about 30 to 65 millimeters. Handle region 14 is preferably about 70 to 100 millimeters in length and is substantially radially symmetric. Region 14 also includes an interior storage chamber accessible by the removing of end cap 16. Blade housing 12 is designed to incorporate a standard utility knife razorblade. Utility knife 10 is made of an inexpensive polymeric material, such as polyolefins, polycarbonates, composite materials or the like. The design of the improved knife 10 allows less expensive material to be used to manufacture the knife and still producing a knife capable of withstanding the force loads commonly applied to a utility knife.

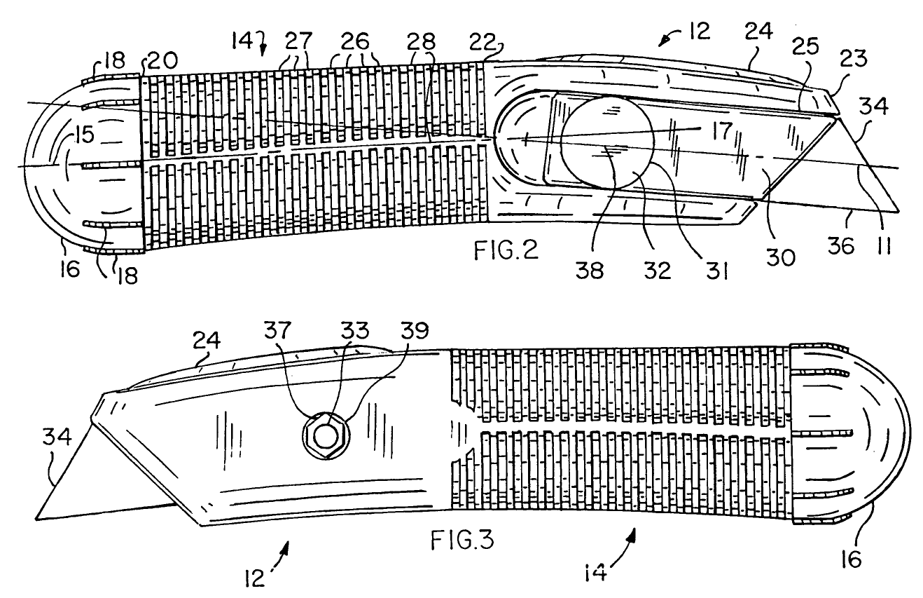

Referring to FIGS. 2 and 3, handle region 14 extends from the back of the handle 20 to the front of handle 22. Handle region 14 cylindrical and slightly tapered such that the diameter at the front of handle 22 is slightly less than the diameter at the end of handle 20. Handle region 14 is radially symmetric about axis 15. Preferably, handle region 14 tapers such that it is slightly frusto-conical in shape. However, it may also be cylindrical, having a constant radius along its length. In one preferred embodiment, the radius gradually declines from about 20 mm at the back of handle 20 to about 16 mm at the front of handle 22, and handle region 14 is about 80 mm long.

A plurality of circumferential ridges 26 wrap around the exterior of handle region 14 perpendicular to axis 15, thereby corrugating handle region 14. Ridges 26 substantially strengthen utility knife 10 thereby substantially increasing the amount of force that may be applied to and through it. Ridges 26 and alternating furrows 27 provide an exterior surface of handle region 14 that facilitates superior gripping. The corrugated surface created by alternating ribs 26 and furrows 27 prevent an operator's hand from slipping up or down the handle region along axis 15. Ribs 26 and furrows 27 are preferably between 2 and 3 millimeters wide. Ribs 26 preferably extend between 2 and 3 millimeters above furrows 27. Ribs 26 are rigid and preferably made from the same material as the rest of the handle region 14. Ribs 26 work synergistically with the optimized diameter of handle region 14 to allow extremely effective gripping by an operator. The strength of grip facilitated by these and other features of handle region 14 is substantial and allows a person with a relatively weak grip to effectively hold and manipulate the utility knife 10.

Handle region 14 also preferably incorporates a plurality of longitudinal ribs 28. In this embodiment, four longitudinal ribs 28 extend across handle region 14 parallel to axis 15 and equidistantly spaced approximately 90 degrees apart from another. Longitudinal ribs 28 provide additional strength to the utility knife 10 without interfering with the gripping action facilitated by ribs 26. Preferably, about three to eight longitudinal ribs 28 are evenly spaced about the circumference of handle region 14. Optimally, as in the embodiment shown, four ribs 28 are spaced 90 degrees apart and extend the entire length of the handle region 14 and have substantially the same dimensions as ribs 26. In this preferred embodiment, longitudinal ribs 28 are approximately 2 to 3 millimeters wide and extend 2 to 3 millimeters above furrows 27.

Blade housing 12 extends from front of handle 22 to front end 23. Blade housing 12 is centered about axis 11. Blade edge is parallel to axis 11. Axis 11 is angled slightly downward from the axis of radial symmetry of the handle region 14, that is axis 15, and blade edge 36 lie parallel to one another. Axis 11 and Axis 15 deviate from one another by about 5 to 15 degrees, preferably about 9 degrees. This angle facilitates transfer of force through utility knife 10 to the edge 36 of blade 34. Blade housing 12 is comprised of housing body 24 which includes a blade channel 25. Blade 34 is inserted into blade channel 25. Once blade 34 is properly placed in channel 25, clench plate 30 is placed within channel 25 such that blade 34 lies between clench plate 30 and housing body 24. Fastening screw 32 is centered about a point along axis 11 and is used to secure clench plate 30 tightly into channel 25 in order to firmly hold blade 34 in place. In this preferred embodiment, fastening screw 32 provides an easy method for loosening clench plate 30. This method requires few moving parts and the large diameter of screw head 38 provides effective contact to be made with knurled edge 31. The large diameter of screw head 38 also allows an operator to provide sufficient torque force to tighten the screw even when applying relatively little torque force to knurled edge 31. Screw head 38 is preferably about 15 to 30 millimeters wide.

Housing body 24 and clench plate 30 are typically smooth, without a corrugated or other pattern upon their surfaces. However, if such a pattern is desirable, one may be incorporated. Because knife 10 may be fashioned from molded or extruded plastics, such aesthetic modifications are easily performed. FIG. 3 shows threaded bore 33 of housing body 24. Bore 33 is threaded such that screw 32 may engage it such that screw 32 tightly secures clench plate 30 into channel 25. Bore 33 may be molded from the same material as the other components of knife 10, or be formed integral with the material of housing body 24. Alternatively, as in this embodiment, securing bore 33 includes bolt 37 which is comprised of metal or an extremely strong material and inserted into bolt hole 39 formed in housing body 24.

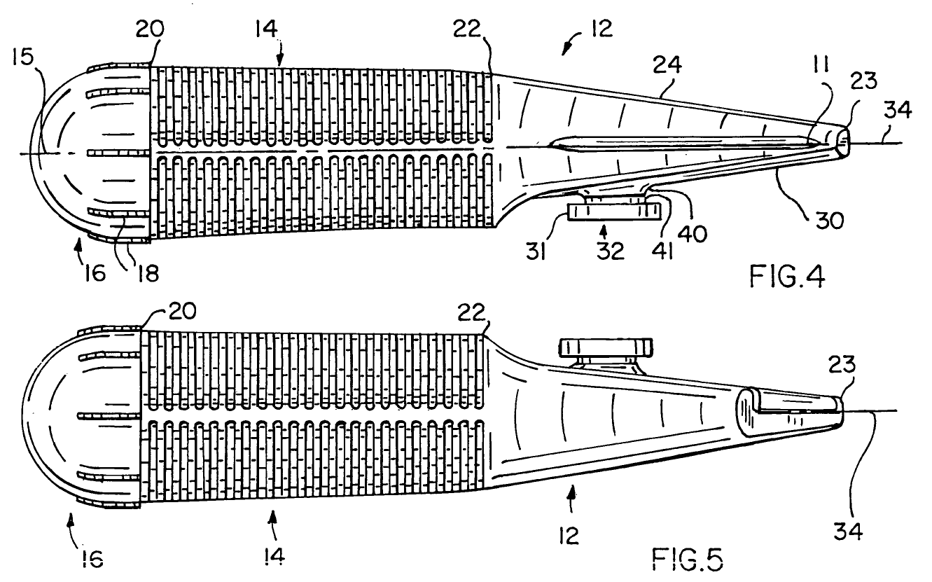

FIGS. 4 and 5 show top and bottom views of the embodiment shown in FIGS. 1-3. In these figures, it can be seen that axes 15 and 11 both lie in the plane of bilateral symmetry of the blade housing 12, and therefore do not deviate to either side in these views of the invention. It may also be seen in FIGS. 4 and 5 that blade housing 12 tapers inwardly between front of handle 22 and the front of housing 23. The angle of tapering is substantially greater than the tapering of handle region 14 between end of handle 20 and front of handle 22. Handle region 14 tapers less in order to provide a handle region that optimally engages an operator's hand. Blade housing 12 tapers more sharply. The tapering of both handle region 14 and blade housing 12 directs the force applied by an operator through handle region 14 into blade 34. This tapering effect maximizes the efficiency with which force applied to handle region 14 is transferred to blade 34. Additionally, the curving of the utility knife 10 resulting from the divergence of axis 11 from axis 15 further enhances the effective transfer of force from handle region 14 to blade edge 36. This allows an operator with a relatively weak grip to apply a substantial amount of force to blade 34 in order to adequately perform the various functions for which a utility knife is commonly used. Furthermore, the symmetric tapering of both the handle region and the blade housing provides both strength to the utility knife 10 and facilitates a more even distribution of force throughout the knife and into the blade.

FIGS. 4 and 5 also show neck 40 of clench plate 30. Neck 40 of clench plate 30 frictionally engages collar 41 of screw 32 to prevent screw 32 from loosening and to firmly hold clench plate 30 in place within housing body 24. Head 31 of fastening screw 32 is preferably knurled or textured along its periphery such that it may be more tightly screwed in place and maximize the frictional engagement between collar 41 and neck 43. Those skilled in the art will appreciate that a variety of screw head designs may also be used that are easily grasped, such as, but not limited to knobs, dials, shoulder type thumbscrews, winged thumbscrews, and cranks.

End cap 16 is radially symmetrical about axis 15. It may be any of a variety of shapes, but is preferably hemispherical in shape and preferably has a series of longitudinal strengthening ribs 18 spaced about it. A preferred hemispherical shape provides for even distribution of any force applied to the end cap 16 to the rest of the utility knife. Furthermore, a hemispherical shape of end cap 16 results in any force applied to it that leads to partially providing force in the direction of the front of the utility knife 23 and into blade 34.

Handle region 14 is preferably 3 to 5 centimeters in diameter, preferably about 4 centimeters in diameter. This results in a handle that is larger than many of the handles described in the prior art. A cylindrical handle of this size is very well suited to conform with the natural size and radius of curvature of a human hand. Because it conforms to the natural shape of the human hand, it is more easily grasped. This allows a person with even a weak grip to firmly hold and manipulate the tool. The tapering of the handle region 14 further aids in preventing the knife 10 from slipping through an operator's grasp along axis 15 in the direction of the front of the knife 23. Often when using the knife as a cutting instrument, substantial force pulls it in the direction of the front of tool 23 along the axis 15. The tapering of handle region 14 allows an operator to counter such a force effectively by simply maintaining the natural shape of his or her hand about the handle region 14. In one preferred embodiment, the handle region 14 has a diameter of about 4 centimeters at back 20 and tapers to a diameter of about 3 centimeters at front 22 and has a length of about 10 centimeters.

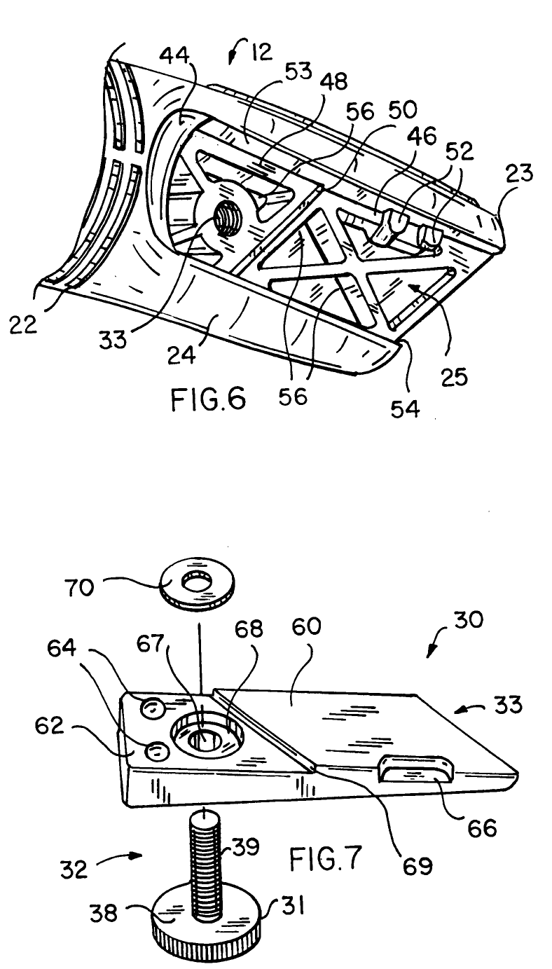

FIG. 6 shows an enlarged view of the blade housing 12 without clench plate 30 in order to show the structure of blade channel 25. Blade channel 25 is formed in blade housing body 24 and defined by upper wall 53, lower wall 54, clenching surface 46 and engaging shelf 48. At one end of blade channel 25 a concave indention 44, which is an optional feature that aids in grasping knife 10 when an operator desires to engage knurled surface 31 of screw 32. Blade channel 25 is deeper along clenching surface 46, which firmly engages a blade within the housing 12. Clenching surface 46 has two tabs 52 that engage slots in a blade to firmly hold it in place. Clenching surface 46 is separated from engaging shelf 48 by shoulder 50. Shoulder 50 is linear and intersects walls 53 and 54 at obtuse angles such that it runs parallel to the side of a utility blade in channel 25. Shoulder 25 is preferably separates shelf 48 and clenching surface 46 by a distance approximately equal to the width of three utility blades, or about 6/100 of an inch. Tabs 52 are preferably raised a distance substantially greater than the width of shoulder 50 to insure firm engagement with a utility blade. Blade channel 25 is angled such that a blade edge protruding from it is parallel to axis 11 shown in FIGS. 2 and 3.

Bore 33 is in the approximate center of shelf 48. Both shelf 48 and clenching surface 46 have a plurality of void spaces 56. These void spaces 56 reduce the amount of material required to manufacture the present invention. However, they have little effect on the function of the invention.

FIG. 6 shows a preferred embodiment having an engaging shelf 48 slightly raised compared to the clenching surface 46. The engaging portion of the blade channel may optionally be at the same level and indistinguishable from the clenching surface. The shoulder and raised shelf of the preferred embodiment provides optimal securement of a blade within the blade channel. However, the invention may be practiced effectively without this feature.

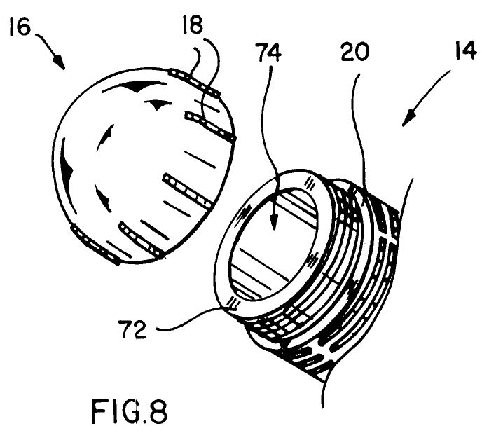

FIG. 7 shows and exploded view of clench plate 30 and securing screw 32. Securing screw 32 has an annular head 38 that has a diameter preferably at least equal to half the diameter of the blade handle region 14, allowing it to be easily and firmly gripped. Head 38 also preferably has a knurled edge 31. The textured edge 31 works synergistically with the relatively large diameter of head 38 to decrease the strength required to loosen and securely tighten the screw 32. The neck 40 of clench plate 30 and collar 41 of screw 32, shown in FIGS. 4 and 5, provide a substantial surface area for the screw 32 and clench plate 30 to frictionally engage and therefore hold clench plate 30 and blade 34 securely in place within channel 25. Collar 41 is optional and neck 40 may engage the head 38 directly. However, it is preferred to incorporate collar 41 to provide greater distance between blade housing 12 and knurled edge 31 to facilitate effective gripping of screw 32.

Interior side 33 of clench plate 30 has several preferred features. Clench surface 60, which directly frictionally contacts a blade within blade channel 25 has a recess 66 that corresponds to tabs 52 found on clenching surface 46 of the blade housing body 24. Clench surface ridge 69 corresponds to shoulder 50 and is similarly about 6/100 of an inch wide. Engaging surface 62 is allows firm engagement of clench plate 30 to blade housing body 24 within channel 25. Surface 62 is parallel to surface 60 and has a bore 67 that includes a washer recess 68. Retainer washer 70 inserts into recess 68 and holds screw 32 in place in bore 67, while allowing it to rotate. Surface 62 also has at least one dimple 64. Dimples 64 are preferably about 4/100 of an inch and strengthen the frictional engagement of clenching plate 30 to both blade housing body 24 and a utility blade within channel 25.

As with the corresponding engaging shelf 48 shown in FIG. 6, engaging surface 62 may be formed at the same level and indistinguishable from clench surface 60. However, the invention may be effectively practiced without incorporation of ridge 69 and a recessed engaging surface. Similarly, the invention may be practiced without the two raised tabs 52 of the blade channel and the corresponding recess 66 in the clench plate, but these features provide superior utility to the improved knife.

One of the beneficial features of the invention is the interaction between the housing body 24 and the clench plate 30 within blade channel 25 due to the use of the fastening screw 32. A blade is held firmly in place within the blade channel 25 between plate 30 and body 24. Tabs 52 extend through slots in a blade and into recess 66. The interaction of tabs 52 with slots in a blade and recess 66, along with friction and pressure provided by fastening screw 32, firmly holds a blade in place. By loosening fastening screw 32 such that tabs 52 are no longer within recess 66, a used blade may be easily removed and replaced. Screw 32 is then once again tightened such that tabs 52 re-enter recess 66, thereby firmly holding a new blade rigidly within blade housing 12. The blade replacement process facilitated by the present invention is efficient and simple.

FIG. 8 shows end cap 16 detached from handle region 14. End cap 16 may be removably attached to handle region 14 by any of a variety of methods known in the art. It is preferable for end cap 16 and handle region 14 to be attached by means of threading as shown on projection 72 such that they may be screwed together. This is preferable in part because longitudinal ribs 18 may serve a secondary function of aiding in the gripping of the end cap 16 as it is attached and detached from the handle region 14. By detaching end cap 16, interior chamber 74 may be accessed. Chamber 74 may be used to store replacement blades for the utility knife or other desired items.

1. An improved utility knife comprising:
a substantially cylindrical, handle region radially symmetrical about an axis having a back end, a front end, a plurality of alternating circumferential ribs and furrows, a plurality of longitudinal ribs, and an interior chamber;
an end cap removably attached to the back end of the handle region;
a blade housing attached to the front end of the handle region having a blade channel, said blade channel comprising an upper wall, a lower wall and a clenching surface;
a clench plate capable of securely clenching a blade within the blade housing; and,
a fastening screw passing a through a bore in the clench plate and removably attached to a bore in the blade channel, such that the clench plate may be tightened to firmly secure a blade within the blade channel and may be loosened to facilitate replacement of the blade.

2. The improved utility knife of claim 1 wherein the handle region has a length of about 10 centimeters.

3. The improved utility knife of claim 2 wherein the handle region tapers such that it has a diameter of about 4 centimeters at the back end and a diameter of about 3 centimeters at its front end.

4. The improved utility knife of claim 1 where in the circumferential ribs and furrows and the at least one longitudinal rib have widths of about 3 millimeters.

5. The improved utility knife of claim 1 wherein the end cap is substantially hemispherical.

6. The improved utility knife of claim 5 wherein the end cap further comprises a plurality of longitudinal ribs.

7. The improved knife of claim 1 wherein the blade channel is angled such that a blade edge of a blade held in the blade channel forms a downward angle of about 5 to 15 degrees with the axis of symmetry of the handle region.

8. The improved utility knife of claim 1 wherein the blade channel further comprises two raised tabs for engaging slots on a blade, and the clench plate further comprises a recess corresponding to the two raised tabs.

9. The improved utility knife of claim 1 wherein the blade channel further comprises an engaging shelf parallel to the clenching surface, and separated from the clenching surface by a shoulder and the clench plate comprises an engaging surface corresponding to the engaging shelf of the blade channel, a clenching surface corresponding to the clenching surface of the blade channel, and a ridge corresponding to the shoulder of the blade channel.

10. An improved utility knife comprising:
a substantially cylindrical handle region radially symmetrical about an axis having a front end and a back end;
an end cap removably attached to the back end of the handle region;
a blade housing attached to the front end of the handle region having a blade channel, said blade channel comprising an upper wall, a lower wall, a clenching surface having two raised tabs for engaging slots on a blade, and an engaging shelf parallel to the clenching surface and separated from the clenching surface by a shoulder;
a clench plate having an engaging surface corresponding to the engaging shelf of the blade channel, a clenching surface corresponding to the clenching surface of the blade channel, and a ridge corresponding to the shoulder of the blade channel;
and a recess corresponding to the two raised tabs of the blade channel,
a fastening screw passing a through a bore in the clench plate and removably attached to a bore in the blade channel, such that the clench plate may be tightened to firmly secure a blade within the blade channel and may be loosened to facilitate replacement of the blade.

11. The improved knife of claim 10 wherein the handle region further comprises a plurality of alternating circumferential ribs and furrows and an interior chamber;

12. The improved knife of claim 10 wherein the blade channel is angled such that a blade edge of a blade held in the blade channel forms a downward angle of about 5 to 15 degrees with the axis of symmetry of the handle region.

13. The improved knife of claim 10 wherein the handle region further comprises a plurality of longitudinal ribs.

14. An utility knife including an elongate handle having a radially central longitudinal axis passing through a vertical plane thereof, said knife comprising:
(a) a removable hollow end piece having a form substantially of a semi-hemisphere having an equatorial cross-section thereof, said semi-hemisphere including an open end having a circumferential sequence of longitudinal ridges thereabout;
(b) a central portion having proximal and a distal ends thereof, said proximal end including means for complemental engagement with said open end of said hollow end of said handle, said central portion defining a conical section having an axial tangent of between about 5 and about 15 degrees relative to said central axis of said handle, said central portion having a greater diameter at said proximal end thereof than at said distal end thereof, said central portion including an axial sequence of circumferential ridges and furrows disposed on a lateral surface of said conical section;
(c) a distal end integrally depending from said distal end of said central portion, said distal end including a recess upon one side thereof, said recess proportioned for complemental, axially slidable engagement with an elongate cutting blade of said knife; and
(d) means for selectably securing said blade within said recess.

15. The utility knife as recited in claim 14, in which a diameter of said semi-hemisphere, at its greatest dimension, falls within a range of about 30 to about 70 millimeters.

16. The utility knife as recited in claim 15, in which a greatest diameter of said distal end of said central portion falls in a range of about 30 to about 70 millimeters.

17. The utility knife as recited in claim 14, in which said ridges of said axial sequence of circumferential ridges are spaced apart from each other by a dimension in a range of 2 to 5 millimeters

18. The utility knife as recited in claim 17, in which the ratio of width to depth of said ridges and furrows falls in a range of 1:0.5 to 1:2.

19. The utility knife as recited in claim 18, in which a ratio of longitudinal width to separation of said ridges and furrows falls within a range of 1:0.5 to 1:2.

20. The utility knife as recited in claim 19, in which a ratio of longitudinal separation to depth of said ridges and furrows falls in a range of 1:0.5 to 1:2.

21. The utility knife as recited in claim 14, in which said means for selectably securing said blade within said recess includes a planar blade-holding element positioned between said complemental recess and a threaded screw which, with said holding element, provides stability to said blade within said distal end.

22. The utility knife as recited in claim 21, in which a diameter of said blade holding element comprises a width similar to that of said blade about a like width to that of said blade.

23. The utility knife as recited in claim 14, in which said proximal end of said central portion includes a hollow region sufficient in size to store replacement blades of the utility knife when said semi-hemispherical end is complementally secured to said proximal end of said central portion.

24. The utility knife as recited in claim 14, in which said distal end reduces in width toward the direction of said vertical plane of said handle in the direction of a distal end of said knife.

25. The utility knife as recited in claim 21, in which said recess includes means for securing said blade along a predetermined axis defining said axial tangent.
